(19) United States
(12) Patent Application Publication
(10) Pub. No.: US 2012/0270192 A1
(43) Pub. Date: Oct. 25, 2012

(54) BEHAVIOR ESTIMATION APPARATUS, BEHAVIOR ESTIMATION METHOD, AND COMPUTER READABLE MEDIUM

(75) Inventors: Tomoko MURAKAMI, Kanagawa (JP); Kentaro Torii, Kanagawa (JP); Tetsuro Chino, Kanagawa (JP); Naoshi Uchihira, Kanagawa (JP)

(73) Assignee: KABUSHIKI KAISHA TOSHIBA, Tokyo (JP)

(21) Appl. No.: 13/421,046

(22) Filed: Mar. 15, 2012

(30) Foreign Application Priority Data
Apr. 20, 2011 (JP) 2011-094288

(51) Int. Cl. G09B 19/00

(52) U.S. Cl. 434/238

(57) ABSTRACT

An example behavior estimation apparatus includes a detection unit to detect sensing information; a first estimation unit to estimate basic actions of a user; a second estimation unit to estimate behavior data in which a plurality of higher-level behaviors made of a combination of the basic actions is arranged in chronological order; an assignment unit to assign any one of a plurality of work behaviors each indicating a behavior related to work to each of the higher-level behaviors, so as to acquire work data; an evaluation unit to evaluate whether the work data satisfies a predetermined standard; a determination unit to determine, when the work data satisfies the predetermined standard, a name of the work behavior assigned to each of the higher-level behaviors; and a display unit to display information according to the name by the determination unit.

### CROSS-REFERENCE TO RELATED APPLICATION(S)

This application is based upon and claims the benefit of priority from Japanese Patent Application No. 2011-094288, filed on Apr. 20, 2011; the entire contents of which are incorporated herein by reference.

### FIELD

Embodiments described herein relate generally to a behavior estimation apparatus, a behavior estimation method, and a computer readable medium.

### BACKGROUND

There has been known a technique of estimating a behavior of a worker, who is carrying out a predetermined work, and displaying a work history of the worker by using the result of the estimation.

However, in the conventional art, there are many sensors required to estimate the behavior of the worker, which is the combination of the basic actions such as “walking”, “running”, and “sitting”. Therefore, the configuration becomes complicated, entailing a problem of increased production cost.

### BRIEF DESCRIPTION OF THE DRAWINGS

FIG. 1 is a block diagram illustrating a behavior estimation apparatus according to an embodiment;

FIG. 2 is a view illustrating an example of mounting the behavior estimation apparatus to a portable terminal device;

FIG. 3 is a view illustrating one example of sensing information;

FIG. 4 is a flowchart illustrating one example of a behavior estimation process;

FIG. 5 is a view illustrating one example of a basic action estimation rule;

FIG. 6 is a view illustrating one example of basic action data;

FIG. 7 is a view for explaining one example of an estimation method of behavior data;

FIG. 8 is a view illustrating one example of work knowledge;

FIG. 9 is a view for explaining one example of an assignment by an assignment unit;

FIG. 10 is a view illustrating one example of an evaluation rule; and

FIG. 11 is a view illustrating a display example by a display unit.

### DETAILED DESCRIPTION

According to one embodiment, a behavior estimation apparatus includes a detection unit that is attached to a user and is configured to detect sensing information used to estimate a plurality of basic actions of the user; a first estimation unit configured to estimate the basic actions based on the sensing information; a second estimation unit configured to estimate behavior data in which a plurality of higher-level behaviors made of a combination of the basic actions is arranged in chronological order, based on basic action data in which the plurality of basic actions; a work data assignment unit configured to assign any one of a plurality of work behaviors each indicating a behavior related to a work to each of the higher-level behaviors, so as to acquire work data in which the plurality of work behaviors is arranged in chronological order; an evaluation unit configured to evaluate whether the work data satisfies a predetermined standard; a determination unit configured to determine, when the work data satisfies the predetermined standard, a name of the work behavior assigned to each of the higher-level behaviors constituting the behavior data as the work behavior corresponding to the higher-level behavior; and a display unit configured to display information according to the name by the determination unit.

An embodiment will be described below in detail with reference to the attached drawings. In the present embodiment, an example of estimating a behavior of a doctor or a nurse, who engages in medical service, will be described. However, the present invention is not limited thereto.

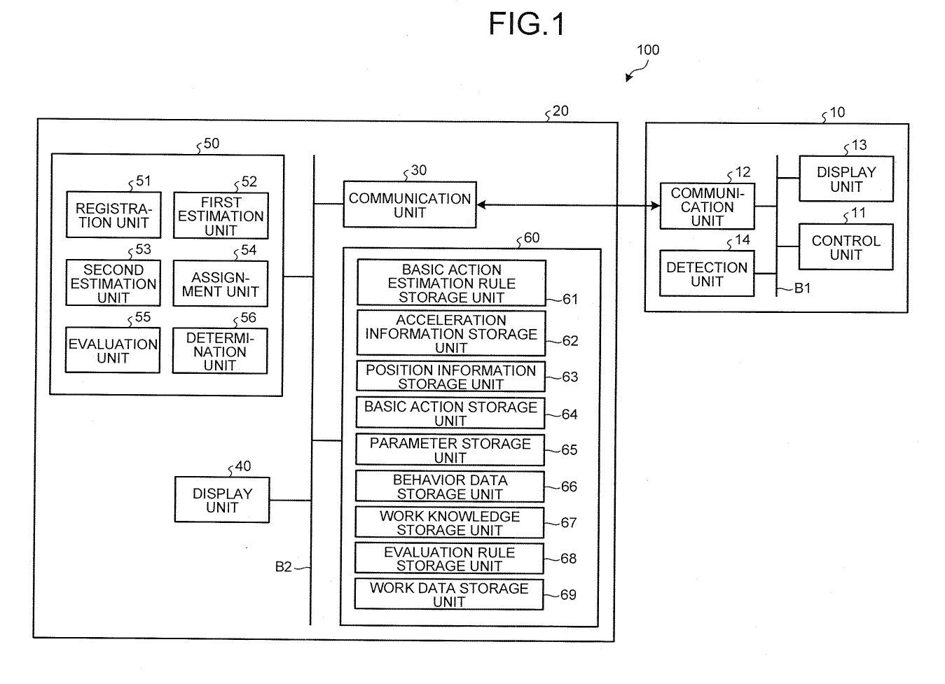

FIG. 1 is a block diagram illustrating a schematic configuration of a behavior estimation apparatus 100 according to the embodiment. As illustrated in FIG. 1, the behavior estimation apparatus 100 includes at least one portable terminal apparatus 10, and a server apparatus 20. Although, in FIG. 1, the number of the portable terminal apparatuses included in the behavior estimation apparatus 100 is one, the embodiment is not limited thereto. The number of the portable terminal apparatus is optional. For example, two or more portable terminal apparatuses 10 may be included in the behavior estimation apparatus 100.

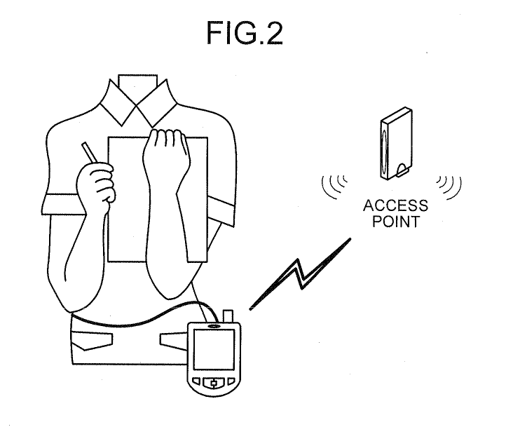

The portable terminal apparatus 10 is put on a user (doctor or nurse) who is the subject of the behavior estimation. Here, as illustrated in FIG. 2, the portable terminal apparatus 10 is put on a waist of the user, for example. As illustrated in FIG. 1, the portable terminal apparatus 10 includes a control unit 11, a communication unit 12, a display unit 13, and a detection unit 14, those being interconnected with a bus B1. The control unit 11 is a unit to control the respective units of the portable terminal apparatus 10, and it is a central processing unit (CPU), for example. The communication unit 12 is a unit for making communication with the server apparatus 20 under the control of the control unit 11. The display unit 13 is a unit for displaying various kinds of information related to the portable terminal apparatus 10, and it may be a liquid crystal panel, for example.

The detection unit 14 is a unit for detecting sensing information used to estimate the basic actions of the user. The basic actions includes simple actions such as “walking”, “running”, “sitting”, “standing”, and “lying”. In the embodiment, as the sensing information, acceleration information indicating acceleration of the portable terminal apparatus 10 (user), and position information indicating the position of the portable terminal apparatus 10 are employed. The sensing information is not limited thereto, and the type of the sensing information is optional. Briefly, the sensing information may be information used to estimate the basic actions of the user.

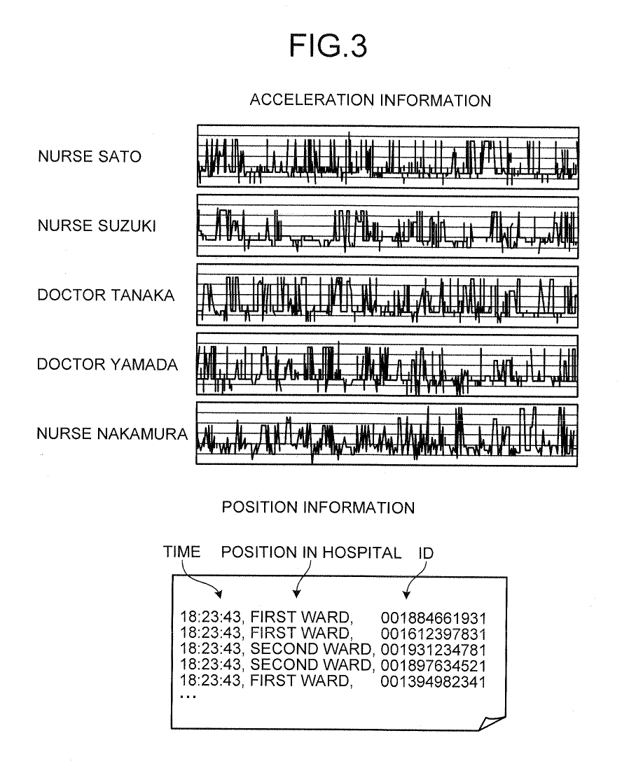

In the embodiment, the detection unit 14 is configured to include an acceleration sensor for detecting the acceleration of the portable terminal apparatus 10, and a position information detection unit for detecting the position information (access point information) that indicates the position of the portable terminal apparatus 10 (i.e., the position of the user) in a hospital. The acceleration sensor is configured to be capable of detecting the acceleration in each of three axial directions of x, y, and z, for example. FIG. 3 is a view illustrating one example of the acceleration information and position information detected by the detection unit 14. The acceleration information of the portable terminal apparatus 10 is stored in a memory (not illustrated) as being associated with a time when the acceleration information is detected. The position information of the portable terminal apparatus 10 is stored in the memory (not illustrated) as being associated with a time when the position information is detected, a position in the hospital indicated by the position information, and an ID for specifying the portable terminal apparatus 10. The control unit 11 controls the communication unit 12 so as to transmit the sensing information (here, the acceleration information and position information) detected by the detection unit 14 to the server apparatus 20 at a predetermined interval (for example, 10 msec).

As illustrated in FIG. 1, the server apparatus 20 includes a communication unit 30, a display unit 40, a control unit 50, and a storage unit 60, which are interconnected with a bus B2. The communication unit 30 is a unit for making communication with the portable terminal apparatus 10 under the control of the control unit 50. The display unit 40 is a unit for displaying various kinds of information related to the server apparatus 20, and it may be a liquid crystal panel, for example.

The control unit 50 is a unit to control the respective units of the server apparatus 20, and it is a computer provided with a CPU, a read only memory (ROM), a random access memory (RAM), and the like, for example. Functions of the control unit 50 includes a registration unit 51, a first estimation unit 52, a second estimation unit 53, an assignment unit 54, an evaluation unit 55, and a determination unit 56. These functions are implemented when the CPU of the control unit 50 reads a control program stored in the ROM onto the RAM and executes the same. Alternatively, at least some of these functions may be implemented by individual circuit (hardware). The control program executed by the control unit 50 can be stored in a computer-readable recording medium such as a compact disk read only memory (CD-ROM), a compact disk recordable (CD-R), a memory card, a digital versatile disk (DVD), and a flexible disk (FD) in a file of an installable or executable format.

The registration unit 51 registers the sensing information into the storage unit 60 when the communication unit 30 receives the sensing information from the portable terminal apparatus 10. In the embodiment, the registration unit 51 registers the acceleration information, received by the communication unit 30, to an acceleration information storage unit 62 included in the storage unit 60, while registering the position information, received by the communication unit 30, to a position information storage unit 63 included in the storage unit 60.

The first estimation unit 52 estimates the basic actions of the user based on the sensing information. In the embodiment, the first estimation unit 52 estimates the basic actions of the user based on a basic action estimation rule stored in a basic action estimation rule storage unit 61 included in the storage unit 60, the acceleration information stored in the acceleration information storage unit 62, and the position information stored in the position information storage unit 63. The detail will be described later. The first estimation unit 52 registers the estimated basic action to a basic action storage unit 64 included in the storage unit 60.

The second estimation unit 53 estimates behavior data in which a plurality of higher-level behaviors made of a combination of the basic actions is arranged in chronological order, based on the basic action data in which a plurality of basic actions estimated by the first estimation unit 52 is arranged in chronological order. The detail will be described later. The second estimation unit 53 registers a parameter (described later) generated for estimating the behavior data to a parameter storage unit 65 in the storage unit 60, and registers the estimated behavior data to a behavior data storage unit 66 included in the storage unit 60.

The assignment unit 54 assigns any one of a plurality of work behaviors, indicating the behavior related to the work, to each of the plurality of higher-level behaviors constituting the behavior data estimated by the second estimation unit 53, thereby obtaining work data in which a plurality of work behaviors is arranged in chronological order. The evaluation unit 55 evaluates whether the work data satisfies a predetermined standard. The determination unit 56 determines a name of the work behaviors respectively assigned to the plurality of higher-level behaviors constituting the behavior data, as the work behaviors corresponding to the higher-level behaviors, when the work data satisfies the predetermined standard. Thus, the work data corresponding to the behavior data estimated by the second estimation unit 53 is determined. The detail will be described later. The determination unit 56 stores the determined work data and a name (e.g., “bedsore round work”) of the work specified by the work data into a work data storage unit 69 included in the storage unit 60 while associating them with each other.

The storage unit 60 is a unit for storing therein various kinds of data. The storage unit 60 includes the basic action estimation rule storage unit 61, the acceleration information storage unit 62, the position information storage unit 63, the basic action storage unit 64, the parameter storage unit 65, the behavior data storage unit 66, a work knowledge storage unit 67, an evaluation rule storage unit 68, and the work data storage unit 69. The basic action estimation rule storage unit 61 stores therein the basic action estimation rule used for estimating the basic action of the user. The acceleration information storage unit 62 stores therein the acceleration information of the user (the portable terminal apparatus 10). The position information storage unit 63 stores therein the position information of the user (the portable terminal apparatus 10). The basic action storage unit 64 stores therein the basic action estimated by the first estimation unit 52. The parameter storage unit 65 stores therein the parameters generated by the second estimation unit 53. The behavior data storage unit 66 stores therein the behavior data estimated by the second estimation unit 53. The work knowledge storage unit 67 stores therein work knowledge. The evaluation rule storage unit 68 stores therein the evaluation rule used for the evaluation by the evaluation unit 55. The work data storage unit 69 stores therein the work data and the name of the work specified by the work data while associating them with each other.

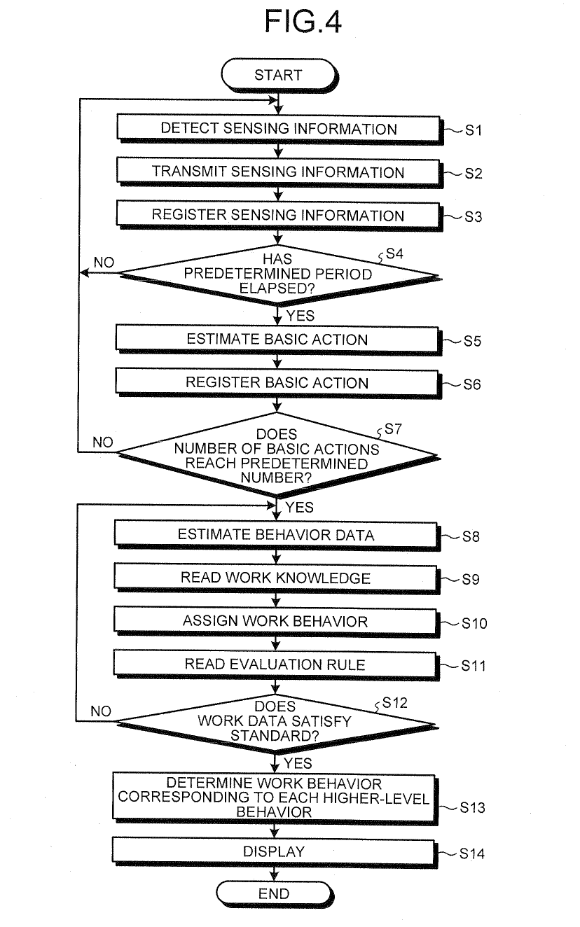

FIG. 4 is a flowchart illustrating one example of a behavior estimation process executed by the behavior estimation apparatus 100. As illustrated in FIG. 4, the detection unit 14 of the portable terminal apparatus 10 first detects the sensing information (step S1). More specifically, the detection unit 14 detects the acceleration information and the position information of the portable terminal apparatus 10 (of the user). Then, the control unit 11 of the portable terminal apparatus 10 controls the communication unit 12 so as to transmit the sensing information, detected by the detection unit 14, to the server apparatus 20 (step S2).

When the communication unit 30 receives the sensing information from the portable terminal apparatus 10, the registration unit 51 of the server apparatus 20 registers the received sensing information to the storage unit 60 (step S3). More specifically, the registration unit 51 executes pre-processing such as a noise removing process for removing noise data from the acceleration information and the position information received by the communication unit 30 and/or a central value calculating process for calculating a central value in a fixed period. Thereafter, the registration unit 51 registers the acceleration information to the acceleration information storage unit 62 included in the storage unit 60, and registers the position information to the position information storage unit 63 included in the storage unit 60. The noise removing process or the central value calculating process may not be executed. What is done by the pre-processing is optional. For example, an average calculation for calculating an average in a fixed period, a frequency calculation, or Fourier transformation can be performed on the acceleration information and the position information received by the communication unit 30 as the pre-processing.

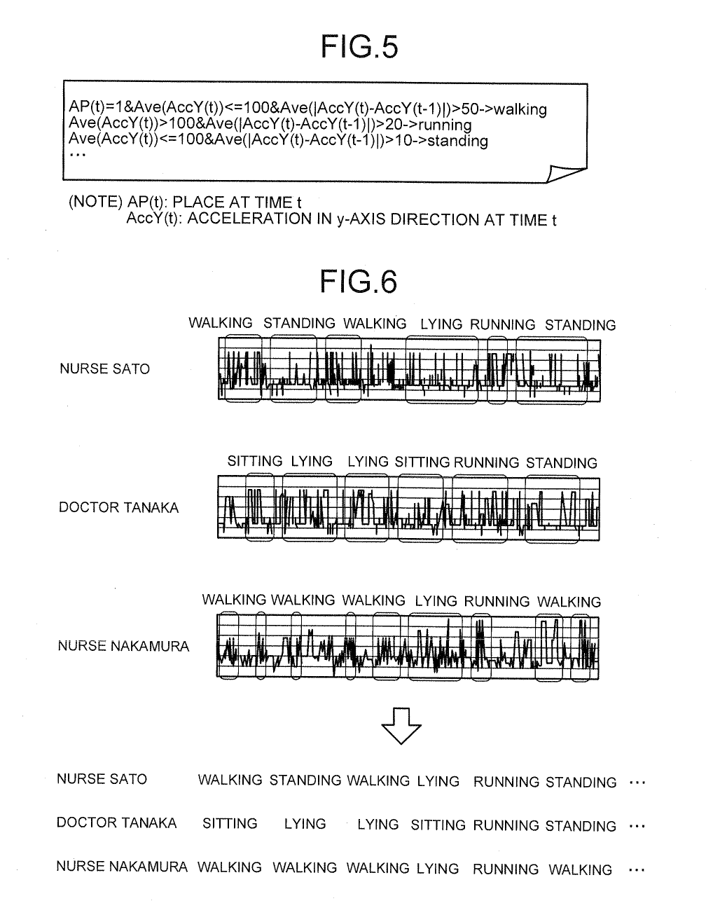

When a predetermined period t1 has elapsed from the start of the behavior estimation process (step S4: YES), the first estimation unit 52 estimates the basic action of the user within the predetermined period t1 (step S5). The more detail will be described below. The first estimation unit 52 reads the acceleration information within the predetermined period t1 from the acceleration information storage unit 62, and reads the position information within the predetermined period t1 from the position information storage unit 63. Then, the first estimation unit 52 reads the basic action estimation rule from the basic action estimation rule storage unit 61, and estimates the basic action of the user by referring to the read basic action estimation rule. FIG. 5 is a view illustrating one example of the basic action estimation rule. In the embodiment, the first estimation unit 52 applies the basic action estimation rule in FIG. 5 to the read acceleration information and the position information, thereby estimating the basic action of the user. “AP(t)=1&Ave(AccY(t))<=100&Ave(|AccY(t)−AccY(t−1)1)>50−>walking” in the first line indicates that “it is determined such that, when the acceleration in the y-axis direction at a time t in a first hospital ward is 100 or less, and the amount of change between the acceleration in the y-axis direction at the time t and the acceleration in the y-axis direction at a time t−1 is 50 or more, the basic action is walking”. The embodiment is not limited thereto, and the detail of the basic action estimation rule can optionally be changed.

Referring back to FIG. 4, after the first estimation unit 52 estimates the basic action in step S5, it registers the estimated basic action to the basic action storage unit 64 (step S6). When the number of the registered basic actions reaches a predetermined number (step S7: YES), the second estimation unit 53 reads one by one the plurality of (the predetermined number of) basic actions from the basic action storage unit 64, and estimates the behavior data, in which the plurality of higher-level behaviors made of the combination of the basic actions is arranged in chronological order, based on the basic action data in which the read plurality of basic actions is arranged in chronological order (step S8). The detail will be described below more specifically.

FIG. 6 is a view illustrating one example of the basic action data of each of nurse Sato, doctor Tanaka, and nurse Nakamura. The case where the behavior data of nurse Sato is estimated will be described below. However, the same will be applied to the other users.

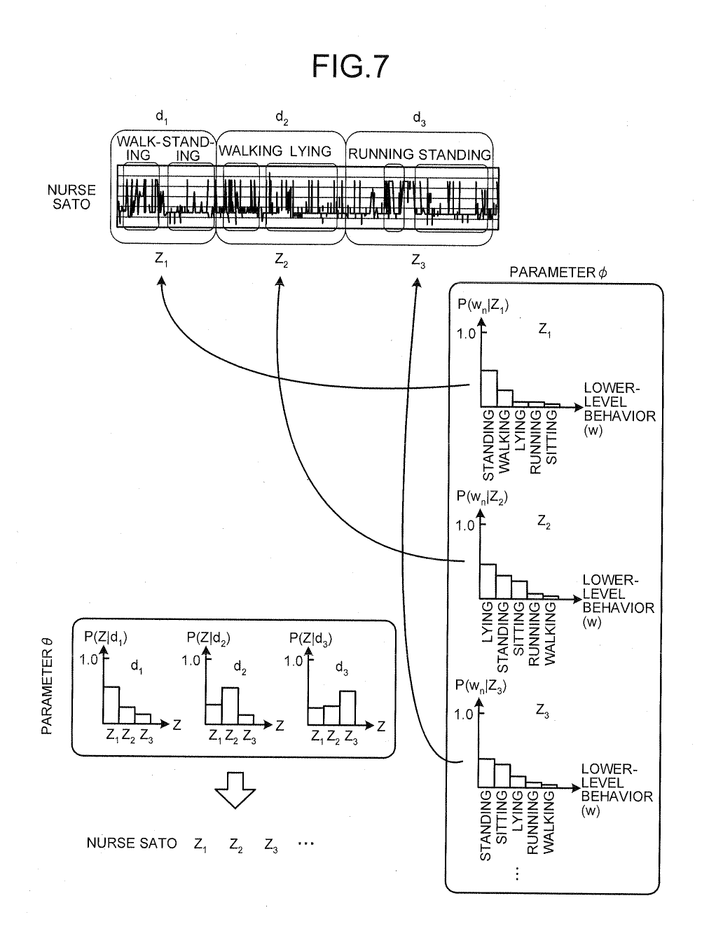

FIG. 7 is a view for explaining the estimation method of the behavior data of nurse Sato. In the embodiment, the second estimation unit 53 estimates the behavior data by applying a topic model to the basic action data. The more detail will be described below. As illustrated in FIG. 7, the second estimation unit 53 divides the basic action data of nurse Sato into a plurality of pieces of data. The number of the divided pieces of data and the length of each of the divided pieces of data can optionally be changed. The second estimation unit 53 estimates an event probability distribution P(z)=θ of a higher-level behavior Z in each of a plurality of pieces of action data d and also estimates an event probability distribution P(w,z)=φ of the basic action w in each higher-level behavior Z. Here, θ and φ are referred to as parameters.

More specifically, when a higher-level behavior (z−ᵢ) is assigned to the basic action other than the specific basic action wᵢ, the second estimation unit 53 calculates a conditional probability P(zᵢ=j|z−ᵢ,wᵢ,dᵢ), indicating that the higher-level behavior j is assigned to the specific basic action wᵢ. With this calculation, the second estimation unit 53 estimates the parameters θ and φ. The conditional probability P(zᵢ=j|z−ᵢ,wᵢ,dᵢ) is calculated with the following equation (1).

P(zᵢ=j|z₋ᵢ,wᵢ,dᵢ)={(C^{WT}_{wij}+β)/Σ^{W}ᵢ₌₁C^{WT}_{wij}+Wβ}×{(C^{DT}_{di j}+α)/Σ^{T}ₜ₌₁C^{DT}_{dit}+Tα} (1)

In the equation (1), C^{WT} indicates the frequency matrix (W×T) of the basic action and the higher-level behavior, and C^{DT} indicates the frequency matrix (D×T) of the behavior data and the higher-level behavior. W, D, and T indicate the number of the basic actions, the number of pieces of the action data, and the number of the higher-level behaviors, respectively. α and β indicate parameters given by a system designer.

The second estimation unit 53 first initializes the values of the elements in the respective matrices C^{WT} and C^{DT} with optional numerical values, and then, randomly changes the values of the elements in the respective matrices so as to calculate the conditional probability P with the equation (1). The second estimation unit 53 sequentially updates the respective matrices C^{WT} and C^{DT} according to the calculation result. The process described above is repeated predetermined number of times, whereby the C^{WT} and C^{DT} are determined. The parameters φ and θ are estimated by using the determined C^{WT} and C^{DT}. The parameters φ and θ are calculated according to the following equations (2) and (3). The probability of the lower-level behavior wᵢ in the higher-level behavior j is represented by φᵢ^{j}, and the probability of the higher-level behavior j in the action data d is represented by θⱼ^{d}.

φᵢ^{j}={(C^{WT}_{wij}+β)/Σ^{W}ᵢ₌₁C^{WT}_{wij}+Wβ} (2)

θⱼ^{d}={(C^{DT}_{dij}+α)/Σ^{T}ₜ₌₁C^{DT}_{dij}+Tα} (3)

In the example of FIG. 7, the event probability distribution θ of the higher-level behaviors (Z₁, Z₂, Z₃) in each of the pieces of the action data (d₁, d₂, d₃), and the event probability distribution φ of the basic actions w (standing, walking, lying, running, sitting) in each of the higher-level behaviors (Z₁, Z₂, Z₃) of nurse Sato are estimated from the calculation described above. The second estimation unit 53 selects, for each of the pieces of action data (d₁, d₂, d₃), one of the higher-level behaviors with the highest probability, thereby estimating the behavior data. In FIG. 7, the probability of the higher-level behavior Z₁ is the highest in the action data d₁, and thus the higher-level behavior Z₁ is selected. In the action data d₂, the probability of the higher-level behavior Z₂ is the highest, and thus the higher-level behavior Z₂ is selected. In the action data d₃, the probability of the higher-level behavior Z₃ is the highest, and thus the higher-level behavior Z₃ is selected. Thus, the behavior data of nurse Sato is estimated as Z₁, Z₂, and Z₃. This is the detail in step S8. The second estimation unit 53 registers the estimated parameters φ and θ to the parameter storage unit 65 included in the storage unit 60.

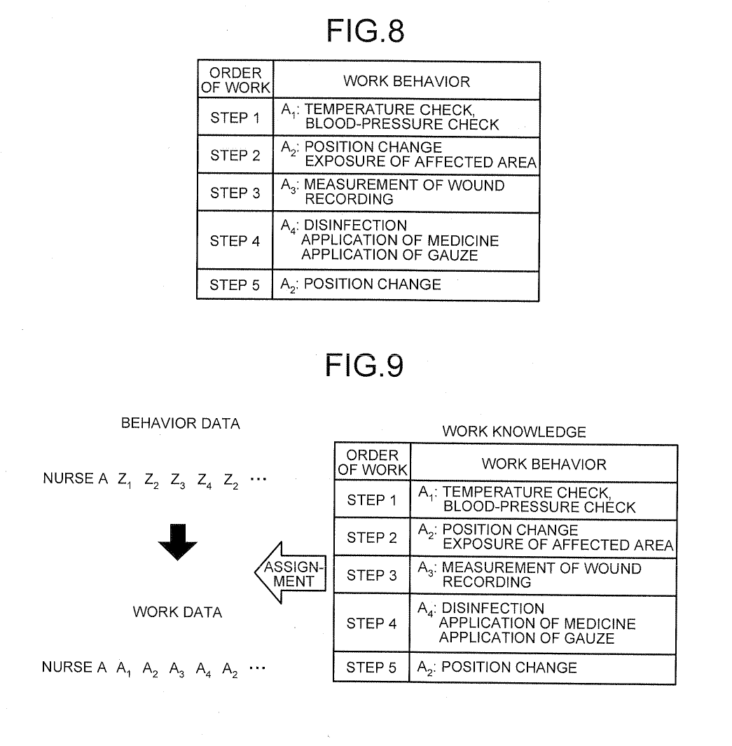

Returning back to FIG. 4, the assignment unit 54 reads the work knowledge from the work knowledge storage unit 67 after step S8 (step S9). FIG. 8 is a view illustrating one example of the work knowledge of the round work for checking and treating bedsore. In FIG. 8, the work knowledge is represented by a work behavior A₁→work behavior A₂→work behavior A₃→work behavior A₄→work behavior A₂. The work behavior A₁ is a temperature check and blood-pressure check. The work behavior A₂ is a position change and exposure of affected area. The work behavior A₃ is a measurement of a wound, and recording. The work behavior A₄ is a disinfection, application of medicine, and application of gauze. The work knowledge is not limited thereto, and any works can be employed as the work knowledge.

Then, the assignment unit 54 assigns any one of the plurality of work behaviors to each of the plurality of higher-level behaviors Z constituting the behavior data estimated in step S8 (step S10). The case where the work behavior is assigned to each of the plurality of higher-level behaviors Z, constituting the behavior data of nurse Sato, will be described below. However, the same is applied to the other users.

FIG. 9 is a view for explaining a specific example of the assignment performed by the assignment unit 54. In FIG. 9, the behavior data of nurse Sato estimated in step S8 is Z₁→Z₂→Z₃→Z₄→Z₂, while the work knowledge read in step S9 is A₁→A₂→A₃→A₄→A₂. In the behavior data of nurse Sato, the second higher-level behavior and the fifth higher-level behavior are the higher-level behavior Z₂, while the second work behavior and the fifth work behavior in the work knowledge are the work behavior A₂. Therefore, each of the plurality of higher-level behaviors Z constituting the behavior data of nurse Sato and each of the plurality of work behaviors A constituting the work knowledge are sequentially associated with each other, whereby the assignment is completed. More specifically, the first work behavior A₁ of the work knowledge is assigned to the first higher-level behavior Z₁ of the behavior data of nurse Sato, the second work behavior A₂ is assigned to the second higher-level behavior Z₂, the third work behavior A₃ is assigned to the third higher-level behavior Z₃, and the fourth work behavior A₄ is assigned to the fourth higher-level behavior Z₄. Thus, the work data can be obtained, in which the plurality of work behaviors is arranged in chronological order. As illustrated in FIG. 9, the work data of nurse Sato is represented as A₁→A₂→A₃→A₄→A₂. This is the detail in step S10 in FIG. 4.

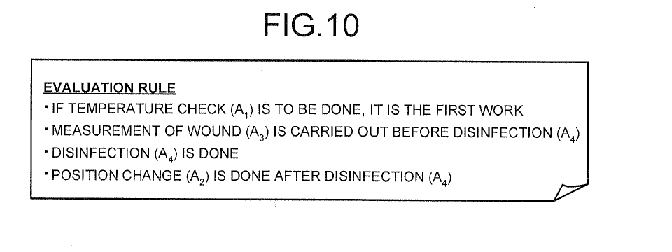

As illustrated in FIG. 4, the evaluation unit 55 reads the evaluation rule from the evaluation rule storage unit 68 after step S10 (step S11). Next, the evaluation unit 55 evaluates whether the work data obtained through the assignment in step S10 satisfies the predetermined standard with reference to the read evaluation rule (step S12). FIG. 10 is a view illustrating one example of the evaluation rule. In FIG. 10, the evaluation rule includes a plurality of evaluation items. When the work data obtained through the assignment satisfies the predetermined number of evaluation items, the evaluation unit 55 evaluates (determines) that the work data satisfies the standard. The evaluation rule is not limited to the one in FIG. 10, and it can optionally be changed.

The evaluation for the work data of “A₁→A₂→A₃→A₄→A₂” of nurse Sato obtained through the assignment will be described as one example. The first evaluation item of the evaluation rule in FIG. 10 is such that “if the temperature check (work behavior A₁) is to be executed, it is the first work”. The first work behavior in the work data of nurse Sato obtained through the assignment is A₁. Therefore, the first evaluation item is satisfied. The second evaluation item in the evaluation rule in FIG. 10 is such that “the measurement of a wound (work behavior A₃) is carried out before disinfection (work behavior A₄). The work behavior A₃ is arranged before the work behavior A₄ in the work data of nurse Sato obtained through the assignment. Therefore, the second evaluation item is satisfied. The third evaluation item in the evaluation rule in FIG. 10 is such that “disinfection (work behavior A₄) is carried out”. Since the work behavior A₄ is included in the work data of nurse Sato obtained through the assignment, the third evaluation item is satisfied. The fourth evaluation item, in the evaluation rule in FIG. 10 is such that “position change (work behavior A₂) is carried out before disinfection (work behavior A₄)”. The work behavior A₂ is arranged before the work behavior A₄ in the work data of nurse Sato obtained through the assignment. Therefore, the fourth evaluation item is satisfied. In this case, the work data of nurse Sato obtained through the assignment satisfies all evaluation items. Accordingly, the result of the assignment of nurse Sato is evaluated to satisfy the standard.

As illustrated in FIG. 4, when the evaluation unit 55 determines that the work data obtained through the assignment in step S10 satisfies the standard (step S12: YES), the process proceeds to step S13. In step S13, the determination unit 56 determines the work behavior A, assigned to each of the plurality of higher-level behaviors Z constituting the behavior data, as the work behavior A corresponding to the higher-level behavior Z. In the example of nurse Sato, the work behavior Aₗ assigned to the higher-level behavior Z₁ is determined as the work behavior corresponding to the higher-level behavior Z₁, the work behavior A₂ assigned to the higher-level behavior Z₂ is determined as the work behavior corresponding to the higher-level behavior Z₂, the work behavior A₃ assigned to the higher-level behavior Z₃ is determined as the work behavior corresponding to the higher-level behavior Z₃, and the work behavior A₄ assigned to the higher-level behavior Z₄ is determined as the work behavior corresponding to the higher-level behavior Z₄. Thus, the work data corresponding to the behavior data of nurse Sato is determined. The determination unit 56 stores the determined work data and the name of the work specified by the work data in the work data storage unit 69 as associating them with each other. In the case of nurse Sato, the work data represented by “A₁→A₂→A₃→A₄→A₂” is associated with the “round work for checking and treating bedsore” specified by the work data, and the resultant is stored in the work data storage unit 69.

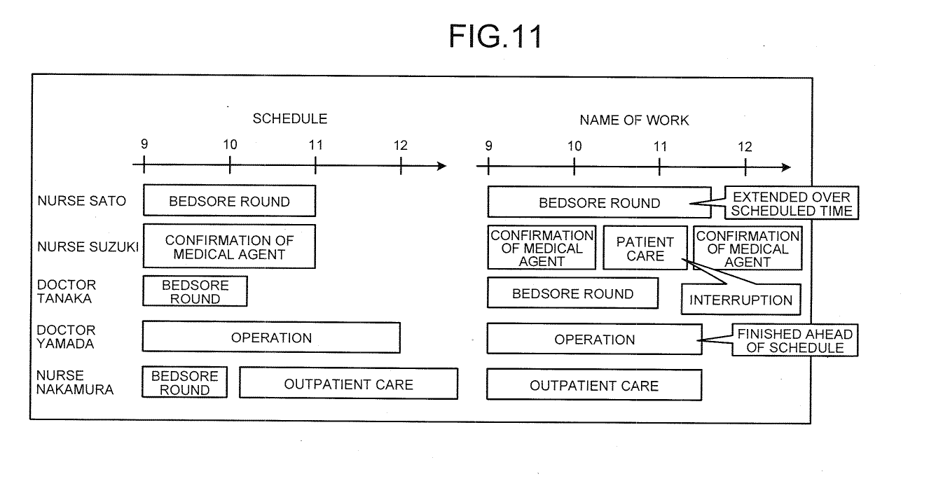

Next, the control unit 50 controls the display unit 40 so as to display the information according to the determination made by the determination unit 56 (step S14). For example, as illustrated in FIG. 11, the name of the work specified by the work data of each user and the scheduled work can be displayed side by side. For example, when the work is done over the scheduled time, it can be displayed that this work is currently done over the scheduled time. When the work is completed earlier than the expected time on the schedule, it can be displayed that the work is finished ahead of schedule. The embodiment is not limited thereto, and the content displayed on the display unit 40 is optional.

On the other hand, when the evaluation unit 55 determines that the work data obtained through the assignment in step S10 does not satisfy the standard in step S12 (step S12: NO), the process returns to the above-mentioned step S8 where the second estimation unit 53 estimates again the behavior data. Specifically, the second estimation unit 53 again performs the process from the determination of the frequency matrices C^{WT} and C^{DT}.

As described above, in the embodiment, the behavior data in which the plurality of higher-level behaviors made of the combination of basic actions is arranged in chronological order is estimated, based on the basic action data in which the plurality of basic actions is arranged in chronological order. Therefore, it becomes possible for the behavior estimation apparatus to have only the sensor(s) for detecting the sensing information used for the estimation of the basic actions. Consequently, the configuration can be simplified and the production cost can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A behavior estimation apparatus comprising:
a detection unit that is attached to a user and is configured to detect sensing information used to estimate a plurality of basic actions of the user;
a first estimation unit configured to estimate the basic actions based on the sensing information;
a second estimation unit configured to estimate behavior data in which a plurality of higher-level behaviors made of a combination of the basic actions is arranged in chronological order, based on basic action data in which the plurality of basic actions;
a assignment unit configured to assign any one of a plurality of work behaviors each indicating a behavior related to a work to each of the higher-level behaviors, so as to acquire work data in which the plurality of work behaviors is arranged in chronological order;
an evaluation unit configured to evaluate whether the work data satisfies a predetermined standard;
a determination unit configured to determine, when the work data satisfies the predetermined standard, a name of the work behavior assigned to each of the higher-level behaviors constituting the behavior data as the work behavior corresponding to the higher-level behavior; and
a display unit configured to display information according to the name by the determination unit.

2. The apparatus according to claim 1, wherein, when the work data does not satisfy the predetermined standard, the second estimation unit estimates again the behavior data.

3. The apparatus according to claim 1, wherein the second estimation unit estimates the behavior data by applying a topic model to the basic action data.

4. The apparatus according to claim 3, wherein the second estimation unit estimates an event probability distribution of the basic action in each of the higher-level behaviors, estimates an event probability distribution of the higher-level behavior in each of a plurality of pieces of action data, which is obtained by dividing the basic action data into plural pieces, and selects one of the higher-level behaviors with the highest event probability in each of the pieces of action data, so as to estimate the behavior data.

5. A behavior estimation method comprising:
estimating a plurality of basic actions of a user based on sensing information that is detected by a detection unit, the detection unit being attached to the user and being configured to detect the sensing information used to estimate the basic actions of the user;
estimating, based on basic action data in which the plurality of basic actions thus estimated is arranged in chronological order, behavior data in which a plurality of higher-level behaviors made of a combination of the basic actions is arranged in chronological order;
assigning, to each of the plurality of higher-level behaviors constituting the behavior data, any one of a plurality of work behaviors each indicating a behavior related to a work, so as to acquire work data in which the plurality of work behaviors is arranged in chronological order;
evaluating whether the work data satisfies a predetermined standard;
determining, when the work data satisfies the predetermined standard, the work behavior assigned to each of the higher-level behaviors constituting the behavior data as the work behavior corresponding to the higher-level behavior; and
displaying information according to the determination made in the determining.

6. A non-transitory computer readable medium including programmed instructions, wherein the instructions, when executed by a computer, cause the computer to execute:
estimating a plurality of basic actions of a user based on sensing information that is detected by a detection unit, the detection unit being attached to the user and being configured to detect the sensing information used to estimate the basic actions of the user;
estimating behavior data in which a plurality of higher-level behaviors made of a combination of the basic actions is arranged in chronological order, based on basic action data in which the plurality of basic actions;
assigning any one of a plurality of work behaviors each indicating a behavior related to a work to each of the higher-level behaviors, so as to acquire work data in which the plurality of work behaviors is arranged in chronological order;
evaluating whether the work data satisfies a predetermined standard;
determining, when the work data satisfies the predetermined standard, a name of the work behavior assigned to each of the higher-level behaviors constituting the behavior data as the work behavior corresponding to the higher-level behavior; and
displaying information according to the name by the determining.
